(19) United States
(12) Patent Application Publication
(10) Pub. No.: US 2017/0066461 A1
(43) Pub. Date: Mar. 9, 2017

(54) MOVING OBJECTS ON SURFACES

(71) Applicant: Gillian MCLEOD, Durham (GB)

(72) Inventor: Gillian MCLEOD, Durham (GB)

(21) Appl. No.: 15/123,336

(22) PCT Filed: Mar. 2, 2015
(86) PCT No.: PCT/GB2015/050603

§ 371 Date: Sep. 2, 2016

(30) Foreign Application Priority Data
Mar. 3, 2014 (GB) 1403686.7
Sep. 16, 2014 (GB) 1416373.7

(51) Int. Cl. B62B 1/00; B60B 33/00; B62B 1/10

(52) U.S. Cl. CPC B62B 1/008; B62B 1/10; B60B 33/0039; B60B 33/0044; B60B 33/0078; B62B 2202/80; B60B 2200/43

(57) ABSTRACT

An apparatus comprises an object (1) and a plurality of roller units (5A-5D) on said object, each roller unit comprising at least one roller element (13) and being switchable between a mobile mode in which the apparatus is moveable across a surface on which said apparatus is positioned in use by rolling on said roller elements, and an immobile mode in which movement of the apparatus across a said surface is inhibited. The roller units (5A-5D) are configured such that manual depression of the object towards a said surface causes switching of at least one roller unit between the mobile and immobile modes.

### FIELD OF THE INVENTION

Roller units and objects with roller units.

### BACKGROUND TO THE INVENTION

The relocation of small to medium-sized appliances (such as laptop computers, home entertainment devices, microwave ovens, washing machines or heavy boxes) within the home or office is a task many people find challenging. In particular, it can be difficult to slide such objects across surfaces such as table tops or floors. This is usually a result of the object's weight, or because of high levels of friction between the object and the surface. In some cases, the sliding force required to overcome friction is simply too high to be applied manually and the object must be lifted from one position into another. In other cases, an applied sliding force may cause the object to slide erratically, leading to alternating modes of both slipping across and sticking to the surface. This can, therefore, result in damage to the object or the surface, or in injury to the person moving the object.

The elderly, or those suffering from physical injuries or disabilities, may find the manipulation of such household objects particularly problematic. Able-bodied people may also injure themselves while trying to manoeuvre such objects, leading to, for example, muscular strains or lower back pain. Such issues affect both office workers and those working, for example, in occupational health or in supported living or sheltered housing environments.

Wheels and castors for use in assisting the movement of large pieces of furniture, for example, are generally known. However, such wheels and castors are not specifically suited for use with small to medium-sized household and office appliances. Objects provided with such castors also generally remain moveable, unless the castors are locked specifically at the castor site. They are not, therefore, suited for quick and easy repeated use (such as when repeatedly rotating a heavy laptop on a table top surface during an office meeting). Those with physical disabilities may also find such locking mechanisms difficult to manipulate. Such wheels and castors are also generally designed to be mounted mechanically onto an object and thus may not be compatible with, for example, existing electronic devices.

### SUMMARY OF THE INVENTION

A first aspect of the invention provides an apparatus comprising an object and a plurality of roller units, each roller unit comprising at least one roller element and being switchable between a mobile mode in which the apparatus is moveable across a surface, on which said apparatus is positioned in use, by rolling on said roller elements, and an immobile mode in which movement of the apparatus across a said surface is inhibited, wherein the roller units are configured such that manual depression of the object towards a said surface causes switching of at least one roller unit between the mobile and immobile modes.

The said roller units may extend from the said object. Typically said roller units extend between the object and the surface on which the apparatus is positioned. The roller units typically support the weight of the object above said surface. In some embodiments, said roller units are mounted onto a lower surface (bottom) of the object. For example, said roller units may be mounted onto said lower surface by mechanical means (for example, said roller units may be screwed onto said lower surface). Alternatively, said roller units may be adhered onto said lower surface (using an adhesive material, for example, a glue or a double-sided adhesive tape). In alternative embodiments, said roller units may extend continuously from said lower surface. In further embodiments, said roller units may be mounted onto or may extend from one or more side surfaces or vertices of the object.

The object typically comprises a small to medium-sized household appliance. For example, the object may comprise a laptop computer, a projector or a washing machine. Typically, the object weighs between 10 g and 100 kg.

The apparatus is typically moveable across the surface on which it is positioned when the roller units are in the mobile mode. The apparatus is typically moveable by rolling across said surface by means of said roller units in the mobile mode. The apparatus typically comprises at least two, at least three or at least four roller units.

Each roller element may be one of the following: a wheel, a castor, a swivel castor, a roller ball.

The roller elements provide the mechanism by which the apparatus is moveable or rollable across the surface on which it is positioned when the roller units are in the mobile mode. A castor is typically taken to encompass a rigid castor comprising a wheel on an axle mounted onto a stationary fork. A swivel castor is typically taken to encompass a wheel on an axle mounted onto a fork comprising a swivel joint which allows said fork to rotate freely about an axis generally perpendicular to the surface on which the apparatus is positioned. A swivel castor therefore typically allows for greater freedom of movement and rotation than a rigid castor. A roller ball is taken to encompass a spherical wheel or a ball transfer unit, comprising a generally spherical ball mounted within and protruding from a cavity, the ball being free to rotate in any direction within the cavity.

Manual depression of the object towards the surface causes switching of at least one roller unit between the mobile and immobile modes. Equivalently, manual application of a force greater than a threshold force to the object in the direction of the surface typically causes at least one of the roller units to switch between the mobile and immobile modes. Depression of the object therefore involves application of a downwards force to the object in a direction generally perpendicular to the plane of the surface. The force, therefore, typically causes the object to move downwards, towards the surface. The force also typically causes compression of one or more elements of the roller units.

The roller units are switchable both from the mobile mode to the immobile mode, or from the immobile mode to the mobile mode, depending on their initial condition.

A variety of mechanisms may be employed to switch roller units between the mobile and immobile modes. For example, switching from the mobile mode to the immobile mode may comprise the application of a mechanical brake to a roller element, and switching from the immobile mode to the mobile mode may comprise the release of said mechanical brake. In some embodiments, control of said mechanical brake is by mechanical means only. In alternative embodiments, said mechanical brake comprises electrical, magnetic or hydraulic control elements. Alternatively, switching from the mobile mode to the immobile mode may comprise lifting or moving a roller element away from the surface, and switching from the immobile mode to the mobile mode may comprise returning said roller element to a position on the surface.

Typically, each roller unit further comprises a stabilising element configured to inhibit movement of the apparatus on the surface when said roller unit is in the immobile mode.

Typically, switching from the immobile mode to the mobile mode comprises lifting or moving a stabilising element of the roller unit away from the surface, and switching from the mobile mode to the immobile mode comprises returning said stabilising element to the surface. Such a stabilising element typically has a high coefficient of friction such that sliding movement of the roller unit across the surface is inhibited in the immobile mode. The stabilising element may comprise a mechanical brake.

Typically, each roller unit further comprises a resilient biasing means configured to switchably hold each roller unit in either of the mobile or immobile modes.

Typically, manual depression of the object towards the surface is required to overcome the resilient biasing means to switch a roller unit between the mobile and immobile modes.

Manual depression of the object to overcome the resilient biasing means typically involves application of a force greater than a threshold force to the object, the threshold force being equivalent to a biasing force within the roller unit. The biasing force typically holds the roller unit in either of the mobile or immobile modes.

Typically, the threshold force is a force required to overcome the resilient biasing means such that each roller unit is switchable between the mobile and immobile modes.

Typically, the resilient biasing means is a spring.

The biasing force is typically provided by the biasing means. The benefit of providing the biasing means (such as a resilient spring) is that the biasing force must be overcome before the mode can be switched, so that the mode is typically not switched by a user accidentally. Said biasing means is also typically required to support at least a quarter, at least a third, or at least half of the weight of the object.

Typically, each roller unit further comprises a pivoting mechanism configured to hold the stabilising element away from the surface when the roller unit is in the mobile mode and to hold the stabilising element in contact with the surface when the roller unit is in the immobile mode.

Typically, manual depression of the object towards the surface to cause at least one of the roller units to switch between the mobile and immobile modes also causes the generation of an audible alert. The audible alert is typically a click sound. The click sound is typically generated by an internal mechanism of the roller unit. The audible alert typically notifies the user that the mode of the roller unit has been changed from mobile to immobile, or immobile to mobile. The audible alert typically notifies the user that the continued depression of the object (or continued application of a downwards force to the apparatus) is no longer required.

A second aspect of the invention provides a method of using the apparatus comprising the steps of: manually depressing the object towards the surface a first time, thereby causing at least one of the roller units to switch from an initially immobile mode to a mobile mode; moving the apparatus across the surface from a first location to a second location by means of the roller units; and manually depressing the object towards the surface a second time, thereby causing at least one of the roller units to switch back from the mobile mode to the immobile mode, thereby locking the apparatus in the second location.

For example, the method of using the apparatus comprising an object and a plurality of roller units may, in one embodiment, be a method of moving a projector across a table top surface from an initial position to a new position, wherein said projector comprises a plurality of roller units. Each of the roller units apart from one may be the mobile mode when the projector is in the initial position. Said method then comprises the first step of pressing down onto a portion of the upper surface of the projector in the direction of the table top surface, and then releasing the applied force, thereby causing the one roller unit in the initial immobile mode to switch to the mobile mode. The projector is then moved across the table top surface to the new position by rolling the projector on the roller units. Pressing down onto the same portion of the upper surface of the projector in the direction of the table top surface for a second time, and then releasing the applied force, then causes the same roller unit to switch from the mobile mode back to the immobile mode. The projector is then locked into the new position.

A third aspect of the invention provides an object having spring loaded ball transfer units, each spring loaded ball transfer unit having a main body, a rotating unit with a roller ball, and a pivot allowing the rotating unit to pivot onto the roller to give 360° movement (functioning as the mobile mode) or to pivot back, holding the object in place (functioning as the immobile mode). Typically, the object further comprises a spring loaded ball transfer unit at each corner. Each rotating unit may comprises an indexing button which is click activatable to pivot the spring loaded ball transfer unit onto the roller ball.

A fourth aspect of the invention provides a spring loaded ball transfer unit comprising a main body, a mounting bracket for attachment to an object, a rotating unit with a roller ball, and a pivot allowing the rotating unit to pivot onto the roller to give 360° movement or to pivot back, holding the object in place. The rotating unit may comprise an indexing button which is click activatable to pivot the spring loaded ball transfer unit onto the roller ball.

A fifth aspect of the invention provides a spring loaded ball transfer unit substantially as described herein with reference to FIGS. 3, 4, 5, 6 and 7.

A sixth aspect of the invention provides an object having spring loaded ball transfer units substantially as described herein with reference to FIGS. 3, 4, 5, 6 and 7.

The invention also extends in a seventh aspect to a miniature, spring loaded ball transfer unit with click action, which will be smaller than a tiny matchstick box. Once attached on each corner of the object simply push down to activate the clicking mechanism in the device, meaning it will pivot onto the roller to give 360° movement. Once the individual is happy with the position of the device, they will push down again to pivot the device back holding the object firmly in place. The device can be used on various objects in the home or office including printers, laptops (especially the large entertainment laptops), ornaments, heavy boxes, televisions, microwaves, toasters and much more. The device is simple to operate with a health and safety element reducing strains or accident in the home or business. The device will be adjusted to accommodate the various weight bearing applications it is to be used on.

The preferred and optional features discussed above are preferred and optional features of each aspect of the invention to which they are applicable.

### DESCRIPTION OF THE DRAWINGS

An example embodiment of the present invention will now be illustrated with reference to the following Figures in which:

FIG. 1 is a perspective view of an object supported by roller units on a surface;

FIG. 2 is a side view of the object supported by roller units on a surface of FIG. 1;

FIG. 3 is a side view of a roller unit in an immobile position mounted on an object;

FIG. 4 is a cross section through part of the roller unit in an immobile position mounted on an object of FIG. 3;

FIG. 5 is an expanded view of a spring mount mechanism of the roller unit of FIG. 4;

FIG. 6 is a cross section through the spring mount mechanism of FIG. 5;

FIG. 7 is a cross section through part of the roller unit mounted on an object of FIG. 3, the roller unit in a mobile position.

### DETAILED DESCRIPTION OF AN EXAMPLE EMBODIMENT

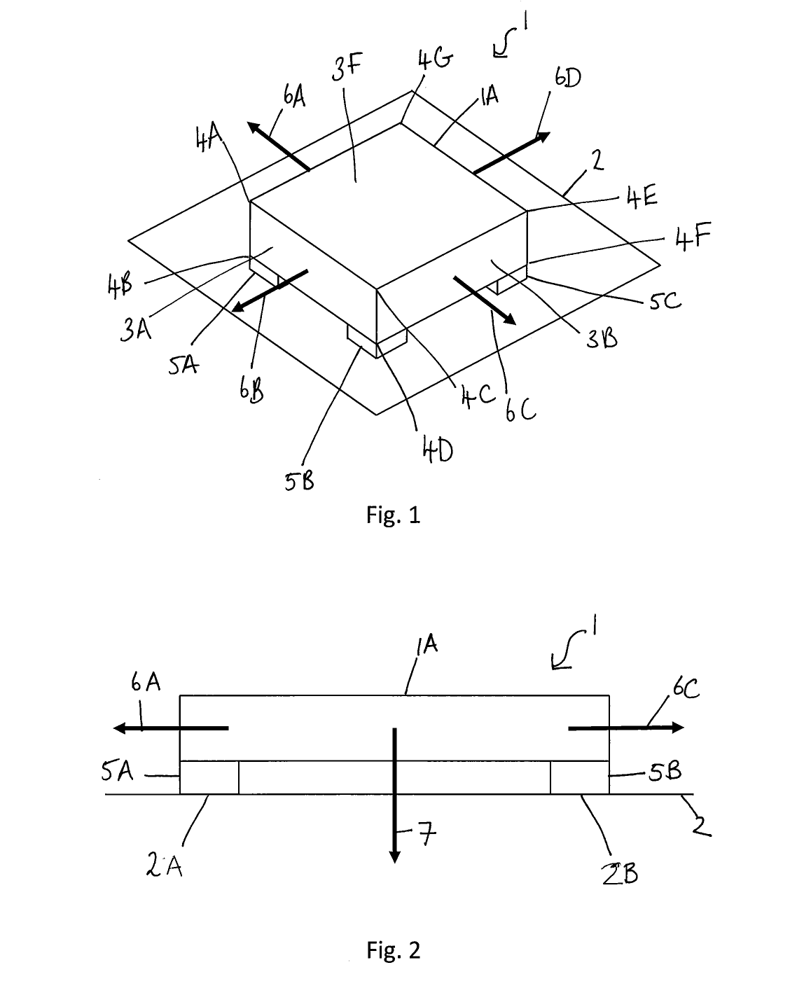

FIG. 1 illustrates schematically an object 1, such as a laptop computer 1, positioned and moveable on a surface 2. The object 1 comprises a generally cuboidal object body 1A, which comprises four side faces 3A, 3B, 3C and 3D extending between a lower face 3E and an upper face 3F. The object body 1A also comprises 8 vertices where the 6 faces 3A, 3B, 3C, 3D, 3E, and 3F meet, labelled 4A, 4B, 4C, 4D, 4E, 4F, 4G and 4H. Four roller units 5A, 5B, 5C and 5D extend from the lower face 3E of the object body 1A, acting as spacing elements between the object body 1A and the surface 2. The object 1 is generally moveable on the surface 2 by means of the roller units 5A, 5B, 5C and 5D. The object 1 is generally moveable in a plane parallel to the surface 2 in the directions indicated by arrows 6A, 6B, 6C and 6D.

As is illustrated schematically in FIG. 2, the weight of the object 1 acts in a direction indicated by arrow 7. The weight of the object 1 therefore generates normal contact forces between the object 1 and the surface 2 at the points of contact 2A, 2B, 2C and 2D between the corresponding roller units 5A, 5B, 5C and 5D and the surface 2. Any movement of the object 1 on the surface 2 in the directions 6A, 6B, 6C and 6D is therefore restricted by any frictional forces arising at these points of contact 2A, 2B, 2C and 2D.

When the frictional forces arising at the points of contact 2A, 2B, 2C and 2D are high, a large force must be applied to the object 1 in a given direction parallel to (or any combination of) directions 6A, 6B, 6C and 6D in order to cause the object 1 to move across the surface 2 in said direction. When the roller units 5A, 5B, 5C and 5D are in an immobile state, the frictional forces arising at the points of contact 2A, 2B, 2C and 2D are high, and a large force is required to move the object 1 across the surface 2 such that sliding of the object 1 is inhibited. The roller units 5A, 5B, 5C and 5D may also be found in a mobile state, in which the force which must be applied to the object 1 to generate movement across the surface 2 in a given direction is low. The transition between the mobile state and the immobile state, or between the immobile state and the mobile state, may be actioned by exerting a downwards force on the object body 1A at or adjacent to one of the vertices 4A, 4B, 4C and 4D in a direction parallel to direction 7, that is to say in a direction towards the surface 2. For example, application of such a downwards force to vertex 4A causes roller unit 5A to transition from the mobile state to the immobile state, or from the immobile state to the mobile state, depending on its initial condition. A subsequent application of a downwards force to vertex 4A then causes the reverse transition of roller unit 5A from the immobile state to the mobile state, or from the mobile state to the immobile state. When all the roller units 5A, 5B, 5C and 5D are in the mobile state, the object 1 is easier to move across the surface 2. When at least one of the roller units 5A, 5B, 5C or 5D is in the immobile state, movement of the object 1 across the surface 2 is inhibited.

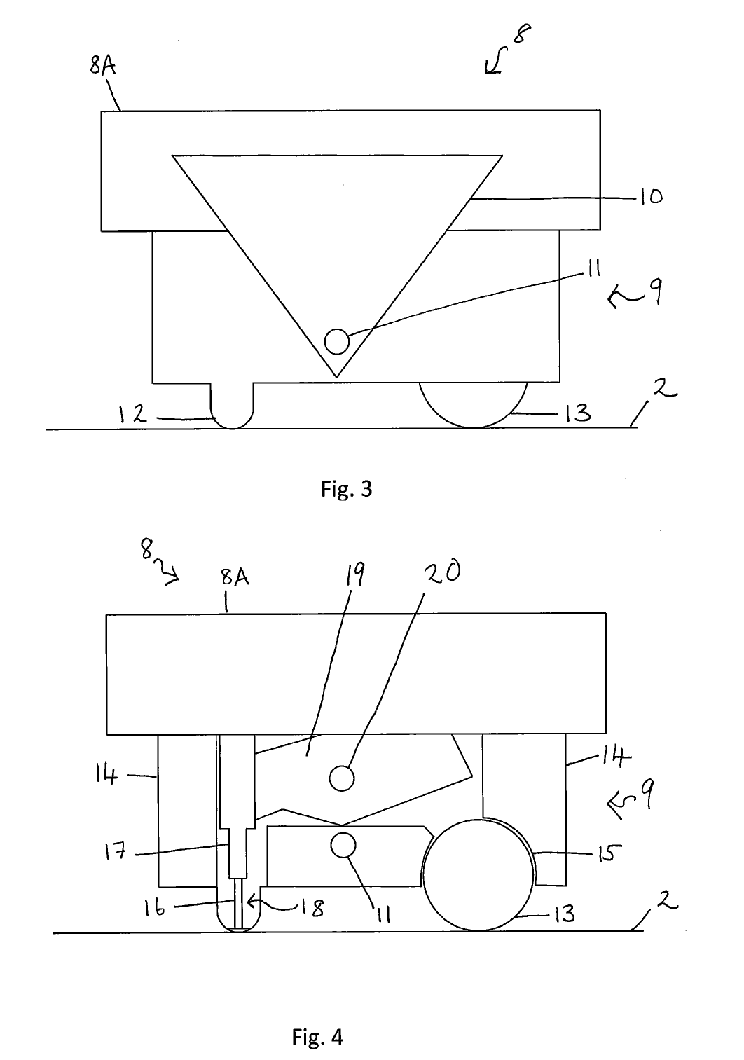

One particular mechanism for achieving the transition between immobile and mobile states of the roller units 5A, 5B, 5C and 5D is illustrated in FIGS. 3 to 7. FIG. 3 shows an object 8 comprising an object body 8A supported above the surface 2 by a roller unit 9. The roller unit 9 is mounted onto the object by means of a mounting bracket 10 extending from the object body 8A. The roller unit 9 is mounted onto the mounting bracket 10 by means of a main pivot screw 11. The roller unit 9 in FIG. 3 is in its immobile state. In the immobile state, the roller unit 9 makes contact with the surface 2 at two points defined by a generally hemispherical stabilising element 12 and a generally spherical roller ball 13. The stabilising element 12 is made of a material with a high coefficient of friction, such as rubber, such that sliding of the object 8 across the surface 2 is inhibited.

The internal mechanism of the roller unit 9 in the immobile position is illustrated in FIG. 4. The roller unit 9 comprises a housing body 14 which retains the roller ball 13 within a generally spherical cavity 15. The roller ball 13 is rotatable within the rotation cavity 15 such that the combination of the roller ball 13 with the rotation cavity 15 functions as a ball transfer unit. The housing body 14 also houses an indexing unit 16 extending from a spring mount 17 within a stabilising element cavity 18. The spring mount 17 is rigidly fixed to a locking arm 19 which is pivotable about a lock pivot screw 20.

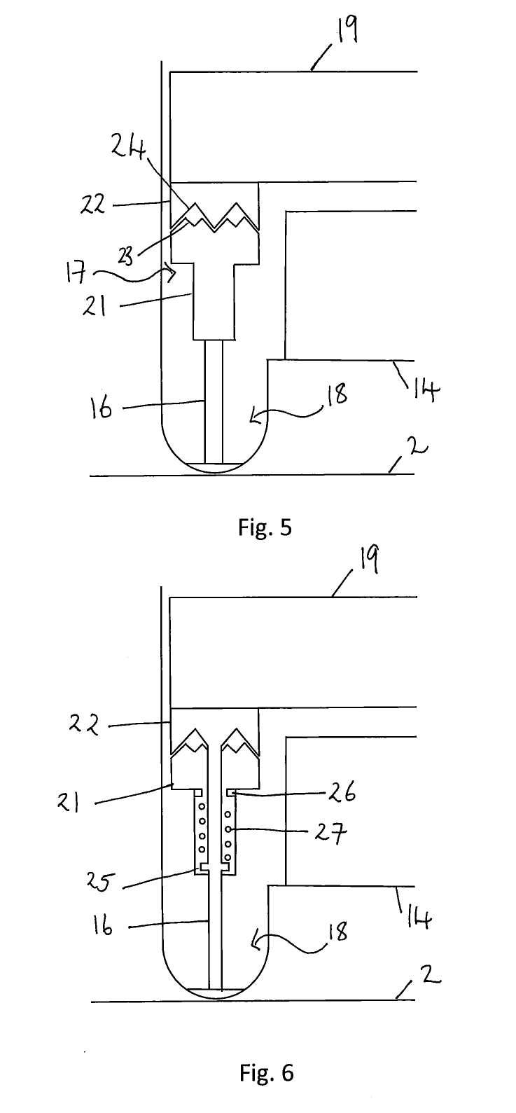

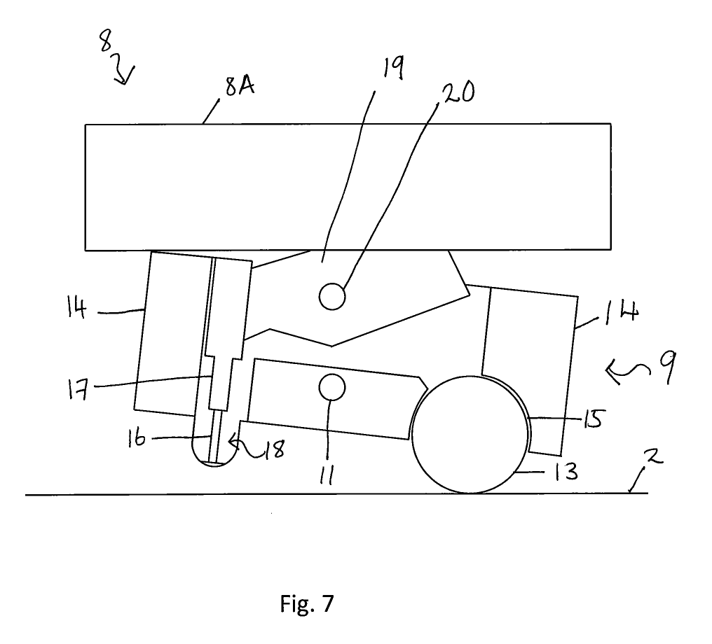

In order to cause a transition between the immobile position (illustrated in FIG. 4) and the mobile position (illustrated in FIG. 7), a downwards force is applied to the object body 8A in the direction of the surface 2 such that the indexing unit 16 is pushed into the spring mount 17 by the stabilising element 12. The spring mount 17 is illustrated in greater detail in FIG. 5. The spring mount 17 comprises two interlocking components, a base element 21 and a top element 22. The base element 21 and the top element 22 are generally cylindrical about a longitudinal axis of the spring mount 17. The base element 21 and the top element 22 also comprise three-dimensional saw-toothed surfaces 23 and 24. The saw-toothed surfaces 23 and 24 are provided opposite one another. Surface 24 has a regular, repeated pattern of saw-toothed teeth and grooves wherein each of the teeth has the same length and each of the grooves has the same depth. Surface 23 has an alternating pattern of deep and shallow saw-toothed grooves, wherein every second groove is deep and every other groove is shallow. In the immobile mode, the teeth of surface 24 are engaged with the deeper grooves of surface 23. In the mobile mode, the teeth of surface 24 are engaged with the shallower grooves of surface 23.

The internal mechanism of the spring mount 17 is illustrated in cross section in FIG. 6. This internal mechanism of the spring mount 17 is generally similar to the commonly-known indexing mechanism of, for example, a retractable ballpoint pen. The indexing unit 16, which is aligned with the longitudinal axis of the spring mount 17, is continuously connected to the top element 22. The indexing unit 16 is provided with flanges 25. The base element 21 is also provided with internal flanges 26. A resilient spring 27 is provided within a cavity of the base element 21, between the flanges 25 of the indexing unit 16 and the internal flanges 26 of the base element 21.

When a force is applied to the body 8A such that the indexing unit 16 is pushed into the spring mount 17, the spring 27 is compressed between the flanges 25 and 26. The two saw-toothed surfaces 23 and 24 are separated. A force is thereby exerted on the locking arm 19, causing said locking arm 19 to pivot about the lock pivot screw 20. The resultant torque exerted on the housing body causes said housing body 14 to pivot about the main pivot screw 11, such that the roller unit 9 pivots about the main pivot screw within the mounting bracket 10. The particular three-dimensional shapes of the surfaces 23 and 24 are configured such that, on reaching a maximum separation of the two surfaces, the teeth of the surface 24 slide into adjacent grooves of the surface 23. When the force applied to the indexing unit 16 is released, the resilient spring 27 urges the two surfaces 23 and 24 back together. The three-dimensional shape of the surface 23 and 24 ensures the teeth of surface 24 slide completely into the adjacent grooves of surface 23, which are now shallower. Since the grooves in surface 23 alternate in depth, the two surfaces 23 and 24 are held apart by a fixed distance, and this mechanism then holds the locking arm 19 in a pivoted position. The direction of the rotation of the housing body 14 about the main pivot screw 11 has the effect of lifting the stabilising element 12 away from the surface 2 when the applied force is released. The roller unit 9 is, therefore, now in the mobile position as illustrated in FIG. 7, and the only point of contact between the roller unit 9 and the surface 2 is through the roller ball 13. Since the roller ball 13 is free to rotate within the rotation cavity 15, the object 8 is moveable across the surface 2 by rolling of the roller ball 13 within the rotation cavity 15. The movement of the object 8 is no longer inhibited by the stabilising element 12.

A subsequent application of a downwards force onto the object body 8A in the direction of the surface 2, such that the indexing unit 16 is again pushed into the spring mount 17 by the stabilising element 12, leads to further compression of the spring 27 and further separation of the surfaces 23 and 24. Once the maximum separation of surfaces 23 and 24 has again been achieved, and the applied force is removed, the spring 27 urges the teeth of surface 24 slide into the adjacent grooves of surface 23, which are once again deeper. There is, therefore, no longer any separation between surfaces 23 and 24. This releases the force on the locking arm 19, allowing said locking arm 19 to pivot back about the lock pivot screw 20. The housing body therefore returns to the immobile position such that the stabilising element 12 makes contact with the surface 2, once again inhibiting sliding of the object 8 across said surface 2.

The internal mechanism of the spring mount 17 also produces a distinctive click sound when the surfaces 23 and 24 repeatedly engage with one another, alerting a user that the mechanism has been successfully activated and the state of the roller unit has been changed.

The various components of the roller unit 9 (including the housing body 14, the indexing unit 16, the spring mount 17 and the locking arm 19) are generally made of a durable plastics material. Such components may, however, be made of alternative materials, for example metals, dependent on the weight of the object body 8A to be supported. The screws 11 and 20 and the spring 27 are also generally made from metal.

Further modifications and variations may be made within the scope of the invention herein disclosed.

An example embodiment will now be described. With reference to FIGS. 3, 4 and 5, the following elements of the embodiment may be identified: a mounting bracket 10, a lock pivot 20, a locking arm 19, a spring mount hole 17, a pivot 11, a rotating index unit 21, an indexing button 12, a roller ball 13 and a main body 14.

The mounting bracket 10 is used to attach to the bottom of any device, including laptops, microwaves either by using strong adhesive double sided tape, which is also heat resistant. The lock pivot 20 is used to hold the device in place whether it be in the stable, solid position or the roller ball action. The locking arm 19 holds this lock pivot in place so the device is held firmly in either position. Spring mount hole 17 is to hold the strong spring in place which operates the click action you the individual pushes down on the device. The pivot 11 provides the smooth action from the stable position to the roller ball 360° degree movement position. The rotating index unit 21 provides the device with the ability to use its click action mechanism and allows it to pivot from one position to the other. The indexing button 12 provides the click action for the mechanism to work. This index button is made of a material that when the object is to remain stable it will hold it in place without an issue of sliding. The roller ball 13 will become active when the click action pivots the device onto the ball to allow 360° degree smooth movement of the object. The main body 14 will be light and durable, but will be adapted according to the various weight categories, for example lightweight, durable plastic, but there are various options for it in the future. This embodiment uses the click action and pivot with locking mechanism on a device for moving objects around the home or office/workplace.

1.-31. (canceled)

32. An apparatus comprising an object and a plurality of roller units, each roller unit comprising at least one roller element and being switchable between a mobile mode in which the apparatus is moveable across a surface, on which said apparatus is positioned in use, by rolling on said roller elements, and an immobile mode in which movement of the apparatus across a said surface is inhibited, wherein the roller units are configured such that manual depression of the object towards a said surface causes switching of at least one roller unit between the mobile and immobile modes.

33. An apparatus according to claim 32, wherein each roller element is one of the following: a wheel, a castor, a swivel castor, a roller ball.

34. An apparatus according to claim 33, wherein each roller unit further comprises a stabilising element configured to inhibit movement of the apparatus on the surface when said roller unit is in the immobile mode.

35. An apparatus according to claim 34, wherein the stabilising element comprises a mechanical brake.

36. An apparatus according to claim 33, wherein each roller unit further comprises a resilient biasing means configured to switchably hold each roller unit in either of the mobile or immobile modes.

37. An apparatus according to claim 36, wherein manual depression of the object towards the surface is required to overcome the resilient biasing means to switch a roller unit between the mobile and immobile modes.

38. An apparatus according to claim 34, wherein each roller unit further comprises a pivoting mechanism configured to hold said stabilising element away from the surface when the roller unit is in the mobile mode and to hold said stabilising element in contact with the surface when the roller unit is in the immobile mode.

39. An apparatus according to claim 32, wherein each said roller unit comprises a spring loaded ball transfer unit having a main body, a rotating unit with a roller ball, and a pivot allowing the rotating unit to pivot onto the roller to give 360° movement or to pivot back, holding the object in place.

40. A method of using the apparatus of claim 32 comprising the steps of: manually depressing the object towards the surface a first time, thereby causing at least one of the roller units to switch from an initially immobile mode to a mobile mode; moving the apparatus across the surface from a first location to a second location by means of the roller units; and manually depressing the object towards the surface a second time, thereby causing at least one of the roller units to switch back from the mobile mode to the immobile mode, thereby locking the apparatus in the second location.

41. An object having spring loaded ball transfer units, each spring loaded ball transfer unit having a main body, a rotating unit with a roller ball, and a pivot allowing the rotating unit to pivot onto the roller to give 360° movement or to pivot back, holding the object in place.

42. An object according to claim 41, wherein each rotating unit comprises an indexing button which is click activatable to pivot the spring loaded ball transfer unit onto the roller ball.

43. A roller unit comprising at least one roller element, the roller unit being switchable between a mobile mode in which the roller unit is moveable across a surface on which said roller unit is positioned in use by rolling on said roller element, and an immobile mode in which movement of the roller unit across a said surface is inhibited, wherein the roller unit is configured such that manual depression of the roller unit towards a said surface causes switching between the mobile and immobile modes.

44. A roller unit according to claim 43, wherein each roller element is one of the following: a wheel, a castor, a swivel castor, a roller ball.

45. A roller unit according to claim 44 further comprising a stabilising element configured to inhibit movement of said roller unit on the surface when said roller unit is in the immobile mode.

46. A roller unit according to claim 45, wherein the stabilising element comprises a mechanical brake.

47. A roller unit according to claim 44 further comprising a resilient biasing means configured to switchably hold said roller unit in either of the mobile or immobile modes.

48. A roller unit according to claim 47, wherein manual depression of the roller unit towards the surface is required to overcome the resilient biasing means to switch the roller unit between the mobile and immobile modes.

49. A roller unit according to claim 45 further comprising a pivoting mechanism configured to hold said stabilising element away from the surface when the roller unit is in the mobile mode and to hold said stabilising element in contact with the surface when the roller unit is in the immobile mode.

50. A spring loaded ball transfer unit comprising a main body, a mounting bracket for attachment to an object, a rotating unit with a roller ball, and a pivot allowing the rotating unit to pivot onto the roller to give 360° movement or to pivot back, holding the object in place.

51. A spring loaded ball transfer unit according to claim 50, wherein the rotating unit comprises an indexing button which is click activatable to pivot the spring loaded ball transfer unit onto the roller ball.
